(19) United States
(12) Patent Application Publication
(10) Pub. No.: US 2017/0222222 A1
(43) Pub. Date: Aug. 3, 2017

(54) NEGATIVE ELECTRODE ACTIVE MATERIAL FOR LITHIUM SECONDARY BATTERY, METHOD OF PREPARING THE SAME, AND LITHIUM SECONDARY BATTERY INCLUDING THE SAME

(71) Applicant: LG Chem, Ltd., Seoul (KR)

(72) Inventors: Yong Ju Lee, Daejeon (KR); Seung Youn Choi, Daejeon (KR); Rae Hwan Jo, Daejeon (KR); Eun Kyung Kim, Daejeon (KR); Hyun Chul Kim, Daejeon (KR); Jung Hyun Choi, Daejeon (KR)

(73) Assignee: LG Chem, Ltd., Seoul (KR)

(21) Appl. No.: 15/515,398

(22) PCT Filed: Oct. 1, 2015
(86) PCT No.: PCT/KR2015/010400

§ 371 Date: Mar. 29, 2017

(30) Foreign Application Priority Data
Oct. 2, 2014 (KR) 10-2014-0133435
Sep. 30, 2015 (KR) 10-2015-0137455

(51) Int. Cl. H01M 4/38; H01M 10/0525; H01M 4/04; H01M 4/587; H01M 4/36

(52) U.S. Cl. CPC H01M 4/386; H01M 4/587; H01M 4/364; H01M 4/0471; H01M 10/0525; H01M 4/366; H01M 2004/021

(57) ABSTRACT

The present invention relates to a negative electrode active material for a lithium secondary battery, a method of preparing the same, and a lithium secondary battery including the negative electrode active material, wherein since the negative electrode active material includes a surface-treated silicon nanoparticle and the surface-treated silicon nanoparticle includes a silicon nanoparticle and a surface treatment layer which is disposed on a surface of the silicon nanoparticle and includes crystalline SiO₂, the negative electrode active material may exhibit significantly improved initial efficiency characteristics as well as excellent lifetime and capacity characteristics when used in a battery.

### TECHNICAL FIELD

### Cross-Reference to Related Applications

This application claims the benefit of Korean Patent Application No. 2014-0133435, filed on Oct. 2, 2014, and No. 2015-0137455, filed on Sep. 30, 2015, in the Korean Intellectual Property Office, the disclosure of which is incorporated herein in its entirety by reference.

### TECHNICAL FIELD

The present invention relates to a negative electrode active material for a lithium secondary battery which may exhibit significantly improved initial efficiency characteristics as well as excellent lifetime and capacity characteristics when used in a battery, a method of preparing the same, and a lithium secondary battery including the negative electrode active material.

### BACKGROUND ART

Demand for secondary batteries as an energy source has been significantly increased as technology development and demand with respect to mobile devices have increased. Among these secondary batteries, lithium secondary batteries having high energy density, high voltage, long cycle life, and low self-discharging rate have been commercialized and widely used. In particular, techniques for developing a high capacity and high power negative electrode active material have been required as the lithium secondary battery market has recently expanded from small-sized lithium secondary batteries used in portable devices to large-sized secondary batteries used in vehicles. Thus, development of non-carbon-based negative electrode active materials based on materials, such as silicon, tin, germanium, zinc, and lead, having a higher theoretical capacity than a carbon-based negative electrode active material has been conducted.

Among the above materials, since a silicon-based negative electrode active material has a capacity (4,190 mAh/g) 11 times or more higher than a theoretical capacity (372 mAh/g) of a carbon-based negative electrode active material, the silicon-based negative electrode active material is on the spotlight as a material for replacing the carbon-based negative electrode active material. However, since volume expansion of the silicon-based negative electrode active material during the intercalation of lithium ions is 3 times or more when silicon is only used, the capacity of a battery tends to decrease as charging and discharging of the battery proceed and safety issues may also occur. Thus, there is a need to develop a number of techniques in order to commercialize the silicon-based negative electrode active material.

Also, there is a limitation in that the silicon-based active material has higher initial efficiency but has lower lifetime characteristics than a silicon oxide (SiO)-based active material. In order to improve the limitation, a research into a method of using nano-sized silicon has conducted. One of the most common methods of preparing the nano-sized silicon is a method of preparing nano-sized silicon particles, particularly, silicon particles having a diameter of a few tens to 100 nm, by grinding large silicon particles. However, the above method has limitations in that surface oxidation of silicon may easily occur during the grinding process and the initial efficiency may be reduced due to amorphous SiO₂ which is formed on the surface of the silicon as a result of the oxidation.

### DISCLOSURE OF THE INVENTION

### Technical Problem

The present invention provides a negative electrode active material for a lithium secondary battery which may exhibit significantly improved initial efficiency characteristics as well as excellent lifetime and capacity characteristics when used in a battery, and a method of preparing the same.

The present invention also provides a negative electrode, a lithium secondary battery, a battery module, and a battery pack which include the above negative electrode active material.

### Technical Solution

To overcome such above limitations, according to an aspect of the present invention, there is provided a negative electrode active material for a lithium secondary battery including a surface-treated silicon nanoparticle, wherein the surface-treated silicon nanoparticle includes a silicon nanoparticle and a surface treatment layer which is disposed on a surface of the silicon nanoparticle and includes crystalline SiO₂.

According to another aspect of the present invention, there is provided a method of preparing a negative electrode active material for a lithium secondary battery including preparing surface-treated silicon nanoparticles in which a surface treatment layer including crystalline SiO₂ is formed on surfaces of silicon nanoparticles by mixing silicon nanoparticles including amorphous SiO₂ on surfaces thereof with an alkali metal compound and performing a heat treatment to convert the amorphous SiO₂ into the crystalline SiO₂.

According to another aspect of the present invention, there is provided a negative electrode for a lithium secondary battery including the above-described negative electrode active material and a lithium secondary battery including the negative electrode.

According to another aspect of the present invention, there is provided a battery module including the above-described lithium secondary battery as a unit cell.

According to another aspect of the present invention, there is provided a battery pack including the battery module.

### Advantageous Effects

A negative electrode active material for a lithium secondary battery according to the present invention may exhibit significantly improved initial efficiency characteristics as well as excellent lifetime and capacity characteristics when used in a battery.

### BRIEF DESCRIPTION OF THE DRAWINGS

The following drawings attached to the specification illustrate preferred examples of the present invention by example, and serve to enable technical concepts of the present invention to be further understood together with detailed description of the invention given below, and therefore the present invention should not be interpreted only with matters in such drawings.

FIG. 1 is a graph illustrating the results of X-ray diffraction spectroscopy (XRD) of a negative electrode active material prepared in Example 1.

### MODE FOR CARRYING OUT THE INVENTION

Hereinafter, preferred embodiments of the present invention will be described with reference to the accompanying drawings to fully explain the present invention in such a manner that it may easily be carried out by a person with ordinary skill in the art to which the present invention pertains. The present invention may, however, be embodied in many different forms and should not be construed as limited to the embodiments set forth herein.

Unless otherwise specified in the present specification, the expression “nanoparticles” denotes particles having an average particle diameter of less than 1 μm, i.e., a few nm to a few hundred nm. In this case, the average particle diameter (D₅₀) may be defined as a particle diameter at 50% in a cumulative particle diameter distribution. The average particle diameter (D₅₀) of the particles according to an embodiment of the present invention, for example, may be measured by using a laser diffraction method. For example, a method of measuring the average particle diameter (D₅₀) of the silicon nanoparticles, for example, may be performed in such a manner that the silicon nanoparticles are dispersed in a solution, the solution is introduced into a commercial laser diffraction particle size measurement instrument (e.g., Microtrac MT 3000) and irradiated with ultrasonic waves having a frequency of about kHz and an output of 60 W, and the average particle diameter (D₅₀) at 50% in a cumulative particle diameter distribution of the measurement instrument may then be calculated.

In the present invention, since amorphous SiO₂, which is disposed on surfaces of silicon nanoparticles during the preparation of a silicon-based negative electrode active material and reduces initial efficiency by an irreversible reaction during initial charging, is changed to electrochemically inactive crystalline SiO₂, the silicon-based negative electrode active material may exhibit significantly improved initial efficiency characteristics as well as excellent lifetime and capacity characteristics without changes in the amount of oxygen in the active material when used in a battery.

That is, a negative electrode active material for a lithium secondary battery according to an embodiment of the present invention includes a surface-treated silicon nanoparticle, wherein the surface-treated silicon nanoparticle includes a silicon (Si) nanoparticle and a surface treatment layer which is disposed on a surface of the silicon nanoparticle and includes crystalline SiO₂.

In the surface-treated silicon nanoparticle, the silicon nanoparticle is a nanoparticle including monolithic silicon and may specifically have an average particle diameter (D₅₀) of 150 nm or less. Thus, excellent lifetime characteristics as well as high initial efficiency may be obtained by including the nanoscale silicon particle. Also, the silicon nanoparticle may have an average particle diameter of 10 nm to 100 nm in consideration of significant improvement.

Furthermore, the silicon nanoparticle includes the surface treatment layer including crystalline SiO₂ on the surface thereof.

The surface treatment layer is formed by converting amorphous SiO₂ present on the surface of the silicon nanoparticle, which is surface oxidized by grinding, into crystalline SiO₂ by a treatment with a basic material, wherein the surface treatment layer may be formed on the surface of the silicon nanoparticle to a uniform thickness. Accordingly, the surface treatment layer may control the volume expansion of the silicon nanoparticle by acting as a buffer layer, and, as a result, the surface treatment layer may improve the lifetime characteristics of the battery by preventing the exfoliation of the active material from an electrode due to the volume expansion of silicon. The surface treatment layer may be formed on the surface of the silicon nanoparticle to a thickness of 1 nm to 20 nm in consideration of a sufficient effect as the buffer layer, and thus, good high-rate charge and discharge efficiency may be obtained by effectively controlling the volume expansion of the silicon nanoparticle. In a case in which the thickness of the surface treatment layer is less than 1 nm, it may be difficult to obtain a sufficient buffering effect on the volume expansion of the silicon, and, in a case in which the thickness of the surface treatment layer is greater than 20 nm, battery characteristics may be reduced. Also, the surface treatment layer, for example, may be formed to a thickness of 2 nm to 10 nm in consideration of significant improvement.

Also, since the crystalline SiO₂ included in the surface treatment layer provides a channel of lithium ions during initial charge and discharge and, simultaneously, is electrically inactive, the crystalline SiO₂ may prevent the reduction of the initial efficiency during the initial charge and discharge. Specifically, the crystalline SiO₂ may be included in an amount of 2 wt % to 15 wt % based on a total weight of the surface-treated silicon nanoparticles. In a case in which the amount of the crystalline SiO₂ is less than 2 wt %, since a conversion rate of the amorphous SiO₂ present on the surface of the silicon nanoparticle to the crystalline SiO₂ is low, the prevent the reduction of the initial efficiency is insignificant, and, in a case in which the amount of the crystalline SiO₂ is greater than 15 wt %, the initial efficiency may be significantly increased, but discharge capacity may be reduced. Also, the crystalline SiO₂ may be included in an amount of 5 wt % to 10 wt % based on the total weight of the surface-treated silicon nanoparticles in consideration of significant improvement.

Furthermore, since the surface treatment layer is formed by the conversion of the amorphous SiO₂ present on the surface of the silicon nanoparticle to the crystalline SiO₂, there are no changes in an amount of oxygen from the silicon nanoparticle including amorphous SiO₂. The amount of oxygen included in the surface-treated silicon nanoparticle may affect the battery characteristics such as the initial efficiency of the battery, wherein the surface-treated silicon nanoparticle in the negative electrode active material according to the present invention may specifically have the amount of oxygen of 10 wt % to 20 wt %, and even if the surface-treated silicon nanoparticle has the amount of oxygen within a range derived from the amount of crystalline SiO₂, a further improved effect may be obtained in terms of the improvement in the initial efficiency of the battery.

Also, the surface treatment layer may further include an unavoidably remaining alkali metal due to the use of an alkali metal compound in the preparation process, particularly, an alkali metal or alkaline earth metal, in an amount of impurities. Specifically, the surface treatment layer may further include an alkaline metal, such as sodium (Na) and potassium (K), in an amount of 10 ppm or less based on the total weight of the surface-treated silicon nanoparticles.

Furthermore, the surface-treated silicon nanoparticles may be used alone, but may be used in combination with a typical negative electrode active material.

Specific examples of the negative electrode active material may be a carbon-based material such as artificial graphite, natural graphite, graphitized carbon fibers, and amorphous carbon; a metallic compound alloyable with lithium such as silicon (Si), aluminum (Al), tin (Sn), lead (Pb), zinc (Zn), bismuth (Bi), indium (In), magnesium (Mg), gallium (Ga), cadmium (Cd), a Si alloy, a Sn alloy, or an Al alloy; a metal oxide which may be doped and undoped with lithium such as SiOₓ(0<x<2), SnO₂, vanadium oxide, and lithium vanadium oxide; or a composite including the metallic compound and carbonaceous material such as a Si—C composite or a Sn—C composite, and any one or a mixture of two or more thereof may be used. Also, amorphous carbon, low crystalline carbon, and high crystalline carbon may be used as the carbon-based material. Typical examples of the low crystalline carbon may be soft carbon and hard carbon, and typical examples of the high crystalline carbon may be amouphous, platy, scaly, spherical, or fibrous natural graphite or artificial graphite, and baked carbon at high temperature such as mesocarbon microbeads (MCMB), Kish graphite, graphitized meso-phase microbeads (MCMB), graphitized carbon fibers, mesophase pitch-based carbon fibers, cokes, pyrolytic carbon, meso-carbon microbeads, mesophase pitches, and petroleum or coal tar pitch derived cokes.

For example, in consideration of the significant improvement in the battery characteristics during the combined use with the surface-treated silicon nanoparticles, the negative electrode active material may be a carbon-based negative electrode active material which is capable of reversibly intercalating and deintercalating lithium ions and, simultaneously, has conductivity. In a case in which the negative electrode active material is used with the carbon-based negative electrode active material, cycle characteristics may be further improved by increasing the conductivity. In particular, in a case in which the carbon-based negative electrode active material is composited, battery lifetime may be increased by improving electrochemical properties for an electrolyte and the electrical conductivity between the active material particles and reducing the volume expansion of silicon-based particles.

The above-described carbon-based negative electrode active material may be preferably included in an amount of 10 wt % to 90 wt % based on a total weight of the negative electrode active material in consideration of effects of the improvement in battery capacity characteristics and the control of the volume expansion of the silicon-based negative electrode active material. In a case in which the amount of the carbon-based negative electrode active material is less than 10 wt %, electric short circuit and volume expansion occurred during charge and discharge may not be effectively suppressed, and, in a case in which the amount of the carbon-based negative electrode active material is greater than 90 wt %, an effect of the increase in capacity due to the use of Si may be insignificant.

Also, in the case that the carbon-based negative electrode active material is used together, the carbon-based negative electrode active material may be used by compositing with the surface-treated silicon nanoparticles through a method, such as surface coating by deposition, coating, or compression, mechanical alloying, and carbonization by the calcination of an organic material, in addition to a method of simple mixing.

Specifically, in a case in which the carbon-based negative electrode active material is composited with the surface-treated silicon nanoparticles, the negative electrode active material according to the embodiment of the present invention may further include a coating layer including the carbon-based negative electrode active material on the surface treatment layer including crystalline SiO₂ in the surface-treated silicon nanoparticles.

In this case, the carbon-based negative electrode active material may be disposed across the entire surface of the surface-treated silicon nanoparticles or may be partially disposed within the above-described amount range. In consideration of the improvement according to the formation of the coating layer including the carbon-based negative electrode active material, the carbon-based negative electrode active material may be preferably formed across the entire surface of the surface-treated silicon nanoparticles and, for example, may be more preferably formed to a uniform thickness across the entire surface of the surface-treated silicon nanoparticles.

Also, in a case in which the carbon-based negative electrode active material is included in the form of a coating layer on the surface of the surface-treated silicon nanoparticles, a thickness of the coating layer may be in a range of 1 nm to 20 nm under conditions satisfying the range of the amount of the carbon-based negative electrode active material in the negative electrode active material. In a case in which the thickness of the coating layer is less than 1 nm, an effect of improving conductivity according to the formation of the coating layer is insignificant, and, in a case in which the thickness of the coating layer is greater than 20 nm, the battery characteristics may be reduced due to the formation of the excessively thick coating layer. For example, the coating layer may be formed to a thickness of 2 nm to 10 nm in consideration of significant improvement.

Furthermore, in the case that the carbon-based negative electrode active material forms the coating layer as described above, the carbon-based negative electrode active material, for example, may be pyrolytic carbon, which is formed by the pyrolysis of a carbon raw material, such as acetylene gas, among the above-exemplified materials.

In a case in which the carbon-based negative electrode active material is composited with the surface-treated silicon nanoparticles by another method, the negative electrode active material according to the embodiment of the present invention may be included in the form of a coating layer including the surface-treated silicon nanoparticles on the surface of the carbon-based negative electrode active material. In this case, the surface-treated silicon nanoparticles may be disposed across the entire surface of the carbon-based negative electrode active material or may be partially disposed, and, in consideration of the compositing with the carbon-based negative electrode active material and the significant improvement according to the formation of the coating layer including the surface-treated silicon nanoparticles, the coating layer including the surface-treated silicon nanoparticles may be formed to a uniform thickness across the entire surface of the carbon-based negative electrode active material.

Also, in a case in which the surface-treated silicon nanoparticles with carbon-based negative electrode active material are included in the form of a coating layer on the surface of the carbon-based negative electrode active material, a thickness of the coating layer may be in a range of 1 nm to 20 nm under conditions satisfying the range of the amount of the carbon-based negative electrode active material in the negative electrode active material. In a case in which the thickness of the coating layer is less than 1 nm, an effect of improving conductivity according to the formation of the coating layer is insignificant, and, in a case in which the thickness of the coating layer is greater than 20 nm, the battery characteristics may be reduced due to the formation of the excessively thick coating layer. For example, the coating layer may be formed to a thickness of 2 nm to 10 nm in consideration of significant improvement.

Also, in the case that the carbon-based negative electrode active material is coated with the surface-treated silicon nanoparticles as described above, the carbon-based negative electrode active material, for example, may be crystalline carbon, such as natural graphite, artificial graphite, and mesocarbon microbeads, among the above-exemplified materials.

The negative electrode active material according to the embodiment of the present invention as described above may be prepared by a method which includes forming a surface treatment layer including crystalline SiO₂ on surfaces of silicon nanoparticles by mixing silicon nanoparticles including amorphous SiO₂ on surfaces thereof with an alkali metal compound and performing a heat treatment to convert the amorphous SiO₂ into the crystalline SiO₂. Accordingly, according to another embodiment of the present invention, a method of preparing the above-described negative electrode active material is provided.

In the method of preparing the negative electrode active material, the silicon nanoparticles including amorphous SiO₂ on surfaces thereof may be prepared by surface oxidation of silicon nanoparticles.

Specifically, silicon nanoparticles are dispersed in an alcohol-based solvent, such as ethanol, and the surface oxidation may be performed by grinding the silicon nanoparticles to have an average particle diameter (D₅₀) of 100 nm or less. The surface-oxidized silicon nanoparticles prepared as the result of the grinding process may have an amount of oxygen in the silicon nanoparticles of 10 wt % to 20 wt % and may have an initial efficiency of 82% or more in an initial charge and discharge test.

In the method of preparing the negative electrode active material, the alkali metal compound may be an alkali-based metal hydroxide, such as LiOH, NaOH, KOH, Be(OH)₂, Mg(OH), or Ca(OH)₂, or a hydrate thereof, and the alkali metal compound, for example, may be NaOH in consideration of reaction efficiency with the surface-oxidized silicon nanoparticles.

Also, the alkali metal compound may be used in a solution phase. In this case, a solvent is not particularly limited as long as it may dissolve the alkali metal compound and is easily removed thereafter. Specifically, a polar solvent, such as water or an alcohol solvent (ethanol or methanol), may be used as the above solvent.

The mixing process of the surface-oxidized silicon nanoparticles and the basic material may be performed by a conventional method.

Also, during the mixing, the alkali metal compound may be used in an amount of 1 part by weight to 10 parts by weight based on 100 parts by weight of the silicon nanoparticles including amorphous SiO₂ on surfaces thereof. In a case in which the amount of the alkali metal compound is less than 1 part by weight, the amount of the crystalline SiO₂ formed after the subsequent heat treatment may be small, and, as a result, the initial efficiency may be reduced. In contrast, in a case in which the amount of the alkali metal compound is greater than 10 parts by weight, since the amount of the crystalline SiO₂ formed after the subsequent heat treatment may be excessively large, the capacity characteristics may be reduced.

Furthermore, in the method of preparing the negative electrode active material, the heat treatment process may be performed by heat treating in a temperature range of 500° C. to 1,000° C. under an inert atmosphere. When the temperature during the heat treatment is less than 500° C., since conversion efficiency of the amorphous SiO₂ into the crystalline SiO₂ may be low, the initial efficiency and lifetime characteristics may be reduced. When the temperature during the heat treatment is greater than 1,000° C., since a large amount of the crystalline SiO₂ may be formed, the capacity characteristics and lifetime characteristics may be reduced.

Also, the heat treatment process may be performed for 5 minutes to 120 minutes under the above condition. In a case in which the reaction time is less than 5 minutes, since the conversion efficiency into the crystalline SiO₂ may be low, the initial efficiency and lifetime characteristics may be reduced. In a case in which the reaction time is greater than 120 minutes, since the reaction time is more than sufficient to form the crystalline silicon dioxide, it is not desirable in terms of energy efficiency.

Since the heat treatment is performed in a state in which the alkali metal compound is present on the surfaces of the surface-oxidized silicon nanoparticles, the formation of the crystalline SiO₂ may be promoted. In a case in which the alkali metal compound is not used, crystalline SiO₂ is not formed even if the heat treatment is performed at the same temperature. Also, the amorphous SiO₂ may be grown as crystalline SiO₂, which is electrochemically inactive (no reaction with lithium), due to the mixing with the alkali metal compound, and an initial coulomb's efficiency (discharge capacity/charge capacity×100, ratio of the amount of lithium initially charged into the silicon-based compound to the amount of lithium initially discharged) may be increased.

The method of preparing the negative electrode active material according to the present invention may selectively further include a drying process for evaporating and removing the polar solvent present in the mixture of the surface-oxidized silicon nanoparticles and the alkali metal compound, which is prepared before the heat treatment process, and resultantly increasing crystalline SiO₂ formation efficiency by the subsequent heat treatment.

The drying process may be performed by a conventional method and may be specifically performed by heating or hot air drying at 80° C. to 120° C.

Also, the method of preparing the negative electrode active material may selectively further include a washing process for removing the alkali metal compound present on the surface of the silicon oxide after the heat treatment process.

The washing process may be performed by a conventional method and may be specifically performed by a method, such as impregnation and rinsing, using a cleaning solution such as water.

Also, the method of preparing the negative electrode active material according to the embodiment of the present invention may further include forming a coating layer including a carbon-based material on the surface treatment layer or coating the surface of the carbon-based material by using silicon nanoparticles having the surface treatment layer formed thereon, after the formation of the surface treatment layer on the surfaces of the silicon nanoparticles.

The forming of the coating layer including a carbon-based material may be performed by a conventional method of forming a carbon-based coating layer, such as surface coating by deposition, coating, or compression of a carbon-based material, mechanical alloying, and carbonization by the calcination of an organic material. In this case, type and amount of the carbon-based material are the same as described above.

Specifically, the coating layer including a carbon-based material on a surface thereof may be formed by reacting the surface-treated silicon nanoparticles prepared as above with a carbon raw material in an atmosphere of an inert gas such as argon. In this case, a carbon material in a gas phase, such as acetylene gas, may be used as the carbon raw material.

Also, the reaction with the carbon raw material may be performed in a temperature range of 700° C. to 1,000° C.

According to another embodiment of the present invention, a negative electrode for a lithium secondary battery including the above-described negative electrode active material is provided.

Specifically, the negative electrode includes a negative electrode current collector and a negative electrode active material layer which is formed on the negative electrode current collector and includes the above-described negative electrode active material.

The negative electrode having the above-described structure may be prepared by a conventional method of preparing a negative electrode and may be specifically prepared by coating the negative electrode current collector with a negative electrode material mixture including a binder and selectively a conductive agent as well as the negative electrode active material and then drying the coated negative electrode current collector.

In this case, the negative electrode current collector is not particularly limited so long as it has high conductivity without causing adverse chemical changes in the batteries, and may be formed of, for example, copper, stainless steel, aluminum, nickel, titanium, baked carbon, copper or stainless steel that is surface-treated with one of carbon, nickel, titanium, silver, or the like, an aluminum-cadmium alloy, or the like.

The above-described negative electrode current collector may have various shapes, for example, a film, a sheet, a foil, a net, a porous body, a foam body, a non-woven fabric body, and the like.

Also, the negative electrode current collector may have a thickness of 3 μm to 500 μm and may have a surface with fine roughness or a pattern to improve bonding strength with the negative electrode active material.

Also, the negative electrode material mixture may be prepared by dissolving and dispersing negative electrode active material and binder as well as selectively a conductive agent in a solvent.

The negative electrode active material is the same as described above.

Also, the binder functions to improve binding between the negative electrode active materials and adhesion between the negative electrode active material and the negative electrode current collector. Specific examples of the binder may be polyvinylidene fluoride (PVDF), polyvinyl alcohol, starch, hydroxypropylcellulose, regenerated cellulose, polyvinylpyrrolidone, tetrafluoroethylene, polyethylene, polypropylene, an ethylene-propylene-diene polymer (EPDM), a sulfonated EPDM, a styrene-butadiene rubber (SBR), a fluoro-based rubber, or various copolymers thereof, and one alone or a mixture of two or more thereof may be used.

Among these materials, aqueous binders may be used in consideration of significant improvement, and, among the aqueous binders, a styrene-butadiene rubber, for example, may be more preferably used in consideration of the significant improvement, adhesion ability of the binder itself, and a high-temperature drying process during the preparation process of the negative electrode.

The above-described binder may be included in the negative electrode mixture material in an amount of 1 wt % to 20 wt % based on a total weight of the negative electrode active material layer.

Also, the conductive agent is selectively used for providing conductivity to the negative electrode, wherein any conductive agent may be used without particular limitation so long as it has suitable electronic conductivity without causing adverse chemical changes in the batteries. Specific examples of the conductive agent may be graphite such as natural graphite and artificial graphite; a carbon-based material such as carbon black, acetylene black, Ketjen black, channel black, furnace black, lamp black, thermal black, and carbon fibers; metal powder or metal fiber, such as copper, nickel, aluminum, and silver, or like; acicular or rod-shaped conductive whiskers such as zinc oxide whiskers, calcium carbonate whiskers, titanium dioxide whiskers, silicon oxide whiskers, aluminum borate whiskers, magnesium borate whiskers, potassium titanate whiskers, silicon nitride whiskers, silicon carbide whiskers, and alumina whiskers; conductive metal oxide such as titanium oxide; or conductive polymers such as polyphenylene derivatives, and one alone or a mixture of two or more thereof may be used.

Among these materials, the carbon-based material, such as carbon black, may be more preferably used in consideration of the significant improvement according to the use of the conductive agent and the high-temperature drying process in the preparation process of the negative electrode.

The conductive agent may be included in the negative electrode mixture material in an amount of 0.5 wt % to 5 wt % based on the total weight of the negative electrode active material layer.

Also, a solvent typically used in the art may be used as the solvent. The solvent may include dimethyl sulfoxide (DMSO), isopropyl alcohol, N-methylpyrrolidone (NMP), acetone, or water, and one alone or a mixture of two or more thereof may be used.

Furthermore, the negative electrode mixture material may further include a thickener with the above-described components. Specifically, the thickener may be a cellulose-based compound such as carboxymethyl cellulose (CMC). The thickener may be included in the negative electrode mixture material in an amount of 1 wt % to 10 wt % based on the total weight of the negative electrode active material layer.

The negative electrode mixture material having the above-described configuration may be coated on one surface of the negative electrode current collector by using a conventional slurry coating method.

Examples of the slurry coating method may be bar coating, spin coating, roll coating, slot die coating, or spray coating, and one or two or more methods thereof may be performed in combination with each other.

Also, when coating with the negative electrode mixture material, the negative electrode mixture material may be coated to an appropriate thickness in consideration of thickness and amount of the active material loaded in the finally prepared negative electrode active material layer.

Thereafter, a drying process is performed on a coating layer of the negative electrode mixture material which is formed on the negative electrode current collector.

In this case, the drying process may be performed by a method, for example, a heating treatment at a temperature, in which the solvent in the negative electrode mixture material may be evaporated, moisture included in the negative electrode may be removed as much as possible, and simultaneously, the adhesion of the binder may be increased, or hot air injection.

Specifically, the drying process may be performed in a temperature range of a boiling point of the solvent or more to a melting point of the binder or less, and may be specifically performed in a temperature range of 100° C. to 150° C. For example, the drying process may be performed in a temperature range of 100° C. to 120° C. for 1 hour to 50 hours at a pressure of 10 torr or less.

Also, a rolling process after the drying process may be performed by a conventional method, and a vacuum drying process may be selectively further performed if necessary.

Furthermore, as another method, the negative electrode mixture material is coated on a separate support and then dried to be prepared in the form of a film, and the negative electrode active material layer may be prepared by separating the prepared film from the support and then laminating and rolling the film on the negative electrode current collector.

In this case, the negative electrode mixture material, the negative electrode current collector, and the coating, drying, and rolling processes are the same as described above.

The negative electrode prepared according to the above-described preparation method may exhibit excellent lifetime characteristics without the reduction of the initial efficiency by including the above-described negative electrode active material or negative electrode material.

Accordingly, according to another embodiment of the present invention, a lithium secondary battery including a negative electrode prepared by the above-described preparation method.

Specifically, the lithium secondary battery includes a negative electrode prepared by the above-described preparation method, a positive electrode, a separator disposed between the negative electrode and the positive electrode, and a non-aqueous electrolyte. In the lithium secondary battery, the negative electrode is the same as described above.

Also, the positive electrode includes a positive electrode current collector and a positive electrode active material layer which is formed on the positive electrode current collector and includes a positive electrode active material.

In this case, the positive electrode current collector is not particularly limited so long as it has conductivity without causing adverse chemical changes in the batteries, and may be formed of, for example, stainless steel, aluminum, nickel, titanium, baked carbon, or aluminum or stainless steel that is surface-treated with one of carbon, nickel, titanium, silver, or the like.

Also, the positive electrode current collector may have a thickness of 3 μm to 500 μm and may have an entire surface with fine roughness to improve bonding strength with the positive electrode active material. For example, the positive electrode current collector may be used in various shapes, for example, a film, a sheet, a foil, a net, a porous body, a foam body, a non-woven fabric body, and the like.

Furthermore, in the positive electrode active material layer, a compound (lithiated intercalation compound) capable of reversibly intercalating and deintercalating of lithium may be used as the positive electrode active material. Specifically, at least one of composite oxide of lithium and a metal, such as cobalt, manganese, nickel, or a combination thereof, may be used, and, for example, a lithium metal compound represented by the following Formula 1 may be used.

LiₓM_{y}M′_{z}O₂ [Formula 1]

(in Formula 1, M and M′ are each independently elements selected from the group consisting of iron (Fe), nickel (Ni), cobalt (Co), manganese (Mn), chromium (Cr), zirconium (Zr), niobium (Nb), copper (Cu), vanadium (V), molybdenum (Mo), titanium (Ti), zinc (Zn), aluminum (Al), gallium (Ga), magnesium (Mg), boron (B), and a combination thereof, and x, y, z are atomic fractions of respectively independent oxide composition elements, wherein 0<x≦1, 0<y≦1, 0<z≦1, and 0<x+y+z≦2).

Among these materials, the positive electrode active material may be selected from the group consisting of LiCoO₂, LiMnO₂, LiNiO₂, lithium nickel manganese cobalt oxide (e.g., Li(Ni_{0.6}Mn_{0.2}Co_{0.2})O₂, LiNi_{0.5}Mn_{0.3}Co_{0.2}O₂, or LiNi_{0.8}Mn_{0.1}Co_{0.1}O₂) or lithium nickel cobalt aluminum oxide (e.g., LiNi_{0.8}CO_{0.15}Al_{0.05}O₂), and a mixture thereof.

The positive electrode as described above may be prepared by a conventional method of preparing a positive electrode and may be specifically prepared by coating a positive electrode current collector with a positive electrode material mixture, which is prepared by dissolving a conductive agent and a binder as well as the positive electrode active material in a solvent, and then drying and rolling the coated positive electrode current collector.

The binder and conductive agent included in the active layer of the positive electrode may be the same as those previously described in the negative electrode.

Also, a solvent typically used in the art may be used as the solvent. The solvent may include dimethyl sulfoxide (DMSO), isopropyl alcohol, N-methylpyrrolidone (NMP), acetone, or water, and one alone or a mixture of two or more thereof may be used.

Thereafter, the coating, drying, and rolling processes of the positive electrode current collector may be performed in the same manner as described in the preparation method of the negative electrode.

Also, the positive electrode may be prepared by separating a film for forming a positive electrode active material layer, which is prepared by coating the positive electrode mixture material on a separate support and then drying the coated support, from the support and then laminating on the positive electrode current collector.

In the lithium secondary battery, the separator may be used without particular limitation so long as it is used as a separator in a typical lithium secondary battery, and, in particular, a separator having high impregnation capacity as well as low resistance to the ion transfer of electrolyte may be used. Specifically, a porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, or a laminated structure of two or more layers thereof may be used. Also, a typical porous nonwoven fabric, for example, a nonwoven fabric formed of high melting point glass fibers or polyethylene terephthalate fibers may be used.

Also, in the lithium secondary battery, the non-aqueous electrolyte includes an organic solvent and a lithium salt.

Any organic solvent may be used as the organic solvent without particular limitation so long as it may function as a medium through which ions involved in an electrochemical reaction of the battery may be moved. Specifically, an ester-based solvent such as methyl acetate, ethyl acetate, γ-butyrolactone, and ε-caprolactone; an ether-based solvent such as dibutyl ether or tetrahydrofuran; a ketone-based solvent such as cyclohexanone; an aromatic hydrocarbon-based solvent such as benzene and fluorobenzene; or a carbonate-based solvent, such as dimethyl carbonate (DMC), diethyl carbonate (DEC), methylethyl carbonate (MEC), ethylmethyl carbonate (EMC), ethylene carbonate (EC), propylene carbonate (PC), and fluoroethylene carbonate (FEC), may be used as the organic solvent.

Among these solvents, the carbonate-based solvent may be preferably used, and, for example, a mixture of a cyclic carbonate (e.g., ethylene carbonate or propylene carbonate) having high ionic conductivity and high dielectric constant, which may increase charge/discharge performance of the battery, and a low-viscosity linear carbonate-based compound (e.g., ethylmethyl carbonate, dimethyl carbonate, or diethyl carbonate) may be more preferably used.

Also, the lithium salt may be used without particular limitation as long as it is a compound capable of providing lithium ions used in the lithium secondary battery. Specifically, LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂ may be used as the lithium salt. The lithium salt may be included in a concentration of about 0.6 mol % to about 2 mol % in the electrolyte.

In order to improve lifetime characteristics of the battery, suppress the reduction in battery capacity, and improve discharge capacity of the battery, at least one additive, for example, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further added to the electrolyte in addition to the electrolyte components. In this case, the additive may be included in an amount of 0.1 wt % to 5 wt % based on a total weight of the electrolyte.

The separator is disposed between the positive electrode and the negative electrode to prepare an electrode assembly, the electrode assembly is disposed in a case, and a lithium secondary battery having the above-described configuration may be prepared by injecting an electrolyte solution into the case.

As described above, since the lithium secondary battery including the negative electrode, which is prepared by the method according to the present invention, stably exhibits excellent discharge capacity, output characteristics, and capacity retention ratio, the lithium secondary battery is suitable for portable devices, such as mobile phones, notebook computers, and digital cameras, and electric vehicle field such as hybrid electric vehicles.

Thus, according to another embodiment of the present invention, a battery module including the lithium secondary battery as a unit cell and a battery pack including the battery module are provided.

The battery module or the battery pack may be used as a power source of at least one medium and large sized device of a power tool; electric vehicles including an electric vehicle (EV), a hybrid electric vehicle (HEV), and a plug-in hybrid electric vehicle (PHEV); or a power storage system.

Hereinafter, examples of the present invention will be described in detail in such a manner that it may easily be carried out by a person with ordinary skill in the art to which the present invention pertains. The invention may, however, be embodied in many different forms and should not be construed as being limited to the examples set forth herein.

### Example 1

Step 1: Preparation of Silicon Nanoparticles Having Amorphous SiO₂ on Surfaces Thereof

ZrO₂ particles having a ball shape and a diameter of 0.1 mm and Si particles having an average particle diameter of 3 μm were mixed in a weight ratio of 10:1 in an ethanol solvent and then milled for 2 hours to prepare silicon nanoparticles (average particle diameter (D₅₀): 100 nm) having amorphous SiO₂ on surfaces thereof.

As a result of performing oxygen analysis on the prepared silicon nanoparticles using infrared absorption spectrometry, it was confirmed that an amount of oxygen was 10 wt % based on a total weight of the particles.

Step 2: Preparation of Negative Electrode Active Material of Silicon Nanoparticles Having Crystalline SiO₂ Layer

1 g of silicon nanoparticles having amorphous SiO₂ on surfaces thereof, which was prepared in step 1, was put in a sodium hydroxide solution, which was prepared by dissolving 30 mg of sodium hydroxide in 100 ml of ethanol, and stirred for 10 minutes or more to prepare a mixed solution including silicon nanoparticles.

Ethanol was evaporated by putting the mixed solution including silicon nanoparticles in an alumina boat which was heated to 80° C. to 120° C. When the evaporation of the solvent was completed, the alumina boat including the resulting reaction product was put in a quartz tube furnace and heat-treated at a temperature of 800° C. for 30 minutes while flowing argon gas. Then, the quartz tube furnace was cooled to room temperature (20 to 25° C.) to prepare silicon nanoparticles including crystalline SiO₂ on surfaces thereof.

The prepared silicon nanoparticles including crystalline SiO₂ were immersed in distilled water for 2 hours and then filtered to remove sodium hydroxide attached to the surfaces thereof. Thus, a negative electrode active material was obtained.

### Example 2

20 g of the negative electrode active material prepared in Example 1 was put in a rotary tube furnace, argon gas was introduced at a flow rate of 0.3 L/min, and the temperature was then increased to 800° C. at a rate of 10° C./min. A negative electrode active material, in which a conductive carbon coating layer was formed on the surfaces of the particles, was prepared by performing a heat treatment for 5 hours while flowing argon gas at a rate of 1.8 L/min and acetylene gas at a rate of 0.5 L/min and rotating the rotary tube furnace at a speed of 15 rpm/min. In this case, the conductive carbon coating layer was included in an amount of 10 wt % based on a total weight of the negative electrode active material.

### Example 3

10 g of powder, in which 15 wt % of the negative electrode active material prepared in Example 1 and 85 wt % of spheroidized natural graphite having an average particle diameter of 16 μm were mixed, was dispersed in 1,000 mL of ethanol, and a surface of the natural graphite was then coated with the negative electrode active material prepared in Example 1 using spray drying. A conductive carbon coating layer was formed on a surface of the resulting composite in the same manner as in Example 2. In this case, the conductive carbon coating layer was included in an amount of 10 wt % based on a total weight of the negative electrode active material.

### Comparative Example 1

The silicon nanoparticles having amorphous SiO₂ on surfaces thereof, which were prepared in step 1 of Example 1, were used as a negative electrode active material.

### Comparative Example 2

90 wt % of silicon nanoparticles having an average particle diameter of 100 nm, in which surfaces thereof were not oxidized, and 10 wt % of crystalline SiO₂ powder having an average particle diameter of 100 nm were uniformly mixed and used as a negative electrode active material.

### Experimental Example 1

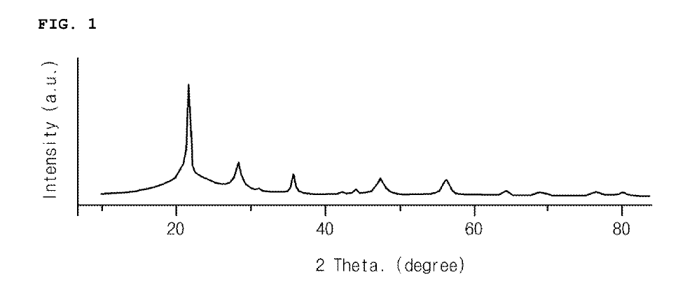

X-ray diffraction spectroscopy (XRD) was performed on the negative electrode active material of the silicon nanoparticles including crystalline SiO₂ on surfaces thereof which were prepared in Example 1. The results thereof are presented in FIG. 1.

From the analysis results, it may be confirmed that crystalline SiO₂ (near 22 degrees) was formed in addition to Si (near 28 degrees).

In addition, in order to identify an amount of the crystalline SiO₂ included in the negative electrode active material which was prepared in Example 1, crystalline MgO was mixed with the negative electrode active material prepared in Example 1, and XRD analysis was then performed.

As a result, the amount of the crystalline SiO₂ included in the negative electrode active material, which was prepared in Example 1, was 10 wt %.

### Experimental Example 2

Structures of the negative electrode active materials prepared in Examples 1 to 3 and Comparative Examples 1 and 2 were analyzed.

Specifically, crystalline MgO was mixed with each of the negative electrode active materials and XRD analysis was then performed in the same manner as in Experimental Example 1, and type and amount of a material for forming a surface-treatment layer in the negative electrode active material were identified from the results of the XRD analysis.

Also, a thickness of each surface-treatment layer was identified through scanning electron microscopic observation.

TABLE 1

| | | | | | Compar- | Compar- |
|---|---|---|---|---|---|---|
| | | | | | ative | ative |
| | | Example 1 | Example 2 | Example 3 | Example 1 | Example 2 |
| Core | Type | Silicon | Silicon | Spheroidized | Silicon | Silicon |
| | | nanoparticle | nanoparticle | natural | nanoparticle | nanoparticle + |
| | | | | graphite | | crystalline |
| | | | | having an | | SiO₂ |
| | | | | average | | |
| | | | | particle | | |
| | | | | diameter of | | |
| | | | | 16 μm | | |
| Surface- | Type | Crystalline | Crystalline | Silicon | Amorphous | — |
| treatment | | SiO₂ | SiO₂ | nanoparticle | SiO₂ | |
| layer | | | | having a | | |
| | | | | surface- | | |
| | | | | treatment | | |
| | | | | layer of | | |
| | | | | crystalline | | |
| | | | | SiO₂ | | |
| | Amount | 10 | 10 | 13.5 | 10 | — |
| | (wt %) | | | | | |
| | Average | 5 | 5 | 5 | 5 | — |
| | thickness | | | | | |
| | (nm) | | | | | |
| Coating | Type | — | Carbon | Carbon | — | — |
| layer | Amount | — | 10 | 10 | — | — |
| | (wt %) | | | | | |
| | Average | — | 5 | 5 | — | — |
| | thickness | | | | | |
| | (nm) | | | | | |

| | | | | | |
|---|---|---|---|---|---|
| Average particle | 100 | 100 | 16,010 | 100 | 100/100 |
| diameter of active | | | | | |
| material (nm) | | | | | |

The amounts shown in Table 1 are values based on the total weight of the negative electrode active material.

### Experimental Example 3

Half cells were prepared by using the negative electrode active materials of Examples 1 to 3 and Comparative Examples 1 and 2, and initial efficiency, capacity, and lifetime characteristics were then respectively evaluated. The results thereof are presented in Table 2.

Specifically, each of the negative electrode active materials prepared in Examples 1 to 3 and Comparative Examples 1 and 2, 5 wt % of carbon black as a conductive agent, a styrene-butadiene rubber (SBR) binder, and carboxymethyl cellulose were mixed in a weight ratio of 80:5:5:10 in distilled water to prepare each composition for forming a negative electrode active material layer, and a copper current collector was coated with the each composition and dried to prepared each negative electrode. Also, an electrolyte solution was prepared by dissolving 1 M lithium hexafluorophosphate (LiPF₆) and 1 wt % of vinylene carbonate and 5 wt % of fluoroethylene carbonate, as additives, based on a total weight of the electrolyte solution in an organic solvent composed of ethylene carbonate (EC) and diethyl carbonate (DEC) (mixed volume ratio of EC/DEC=3/4/3). Half cells (Li metal was used as a counter electrode) were prepared by using the above-prepared negative electrodes and electrolyte solution.

Charge and discharge of the prepared half cell were performed at room temperature (25° C.) under conditions of 0.1 C/0.1 C, discharge capacity and initial efficiency were then measured, and initial charge and discharge characteristics were evaluated therefrom.

Also, charge and discharge were repeated 50 cycles under conditions of 0.5 C/0.5 C, and lifetime characteristics were identified from a capacity retention ratio up to a 50^{th} cycle.

TABLE 2

| | | | | Compar- | Compar- |
|---|---|---|---|---|---|
| | | | | ative | ative |
| | Example 1 | Example 2 | Example 3 | Example 1 | Example 2 |
| Discharge | 2,250 | 2,186 | 630 | 2,268 | 1,952 |
| capacity | | | | | |
| (mAh/g) | | | | | |
| Initial | 89.7 | 90.2 | 91.6 | 81.7 | 84.1 |
| efficiency | | | | | |
| (%) | | | | | |
| Capacity | 83 | 94 | 98 | 81 | 56 |
| retention | | | | | |
| ratio (%) | | | | | |

From the measurement results, the batteries of Examples 1 and 2 including the negative electrode active materials according to the present invention exhibited significantly improved effects in terms of the initial efficiency and lifetime characteristics while also having the same level of discharge capacity in comparison to Comparative Examples 1 and 2. The negative electrode active material of Example 3, in which the amount of graphite was 85 wt %, exhibited a significantly lower discharge capacity than Examples 1 and 2 and Comparative Examples 1 and 2, but exhibited the best effects in terms of the initial efficiency and capacity retention ratio.

1. A negative electrode active material for a lithium secondary battery, comprising:
a surface-treated silicon nanoparticle,
wherein the surface-treated silicon nanoparticle comprises a silicon nanoparticle and a surface treatment layer which is disposed on a surface of the silicon nanoparticle and includes crystalline SiO₂.

2. The negative electrode active material for a lithium secondary battery of claim 1,
wherein the crystalline SiO₂ is included in an amount of 2 wt % to 15 wt % based on a total weight of the surface-treated silicon nanoparticle.

3. The negative electrode active material for a lithium secondary battery of claim 1,
wherein the silicon nanoparticle has an average particle diameter (D₅₀) of 150 nm or less.

4. The negative electrode active material for a lithium secondary battery of claim 1,
wherein the surface treatment layer has a thickness of 1 nm to 20 nm.

5. The negative electrode active material for a lithium secondary battery of claim 1, further comprising a carbon-based negative electrode active material.

6. The negative electrode active material for a lithium secondary battery of claim 5,
wherein the carbon-based negative electrode active material is included in an amount of 10 wt % to 90 wt % based on a total weight of the negative electrode active material.

7. The negative electrode active material for a lithium secondary battery of claim 1, further comprising a coating layer including a carbon-based negative electrode active material on the surface treatment layer.

8. The negative electrode active material for a lithium secondary battery of claim 1, further comprising a carbon-based negative electrode active material,
wherein the surface-treated silicon nanoparticle is disposed on a surface of the carbon-based negative electrode active material.

9. A method of preparing a negative electrode active material for a lithium secondary battery, the method comprising preparing surface-treated silicon nanoparticles in which a surface treatment layer including crystalline SiO₂ is formed on surfaces of silicon nanoparticles by mixing silicon nanoparticles including amorphous SiO₂ on surfaces thereof with an alkali metal compound and performing a heat treatment to convert the amorphous SiO₂ into the crystalline SiO₂.

10. The method of claim 9,
wherein the silicon nanoparticles including amorphous SiO₂ on surfaces thereof are prepared by dispersing silicon nanoparticles in an alcohol-based solvent and grinding the silicon nanoparticles.

11. The method of claim 9,
wherein the silicon nanoparticles including amorphous SiO₂ on surfaces thereof have an average particle diameter of 150 nm or less.

12. The method of claim 9,
wherein the alkali metal compound comprises at least one selected from the group consisting of LiOH, NaOH, KOH, Be(OH)₂, Mg(OH)₂, Ca(OH)₂, and a hydrate thereof.

13. The method of claim 9,
wherein the alkali metal compound is used in an amount of 1 part by weight to 10 parts by weight based on 100 parts by weight of the silicon nanoparticles including amorphous SiO₂ on surfaces thereof.

14. The method of claim 9,
wherein the heat treatment is performed in a temperature range of 500° C. to 1,000° C. in an inert atmosphere.

15. The method of claim 9, further comprising forming a coating layer including a carbon-based negative electrode active material on the surface treatment layer of the surface-treated silicon nanoparticles; or mixing with a carbon-based negative electrode active material to form a coating layer including the surface-treated silicon nanoparticles on a surface of the carbon-based negative electrode active material, after the preparing of the surface-treated silicon nanoparticles.

16. A negative electrode for a lithium secondary battery comprising the negative electrode active material of claim 1.

17. A lithium secondary battery comprising the negative electrode of claim 16.

18. A battery module comprising the lithium secondary battery of claim 17 as a unit cell.

19. A battery pack comprising the battery module of claim 18.

20. The battery pack of claim 19,
wherein the battery pack is used as a power source of a medium and large sized device.

21. (canceled)
